(19) United States
(12) Patent Application Publication
(10) Pub. No.: US 2024/0419819 A1
(43) Pub. Date: Dec. 19, 2024

(54) CONTEXT-AWARE DATA LEAKAGE PREVENTION SYSTEM USING NATURAL LANGUAGE PROCESSING AND RISK PROFILES

(71) Applicant: Saudi Arabian Oil Company, Dhahran (SA)

(72) Inventor: Sultan Saadaldean Alsharif, Al-Khobar (SA)

(21) Appl. No.: 18/334,117

(22) Filed: Jun. 13, 2023

(51) Int. Cl. G06F 21/60; G06F 21/62

(52) U.S. Cl. CPC G06F 21/606; G06F 21/604; G06F 21/6209

(57) ABSTRACT

Systems and methods include a computer-implemented method for blocking the transfer of sensitive information. A document is analyzed by a leakage prevention system for sensitive information. The document is sent by a sender to at least one receiver. A context in which sensitive information is used in the document is determined. A sender risk profile of the sender and receiver risk profiles of the at least one receiver are determined. Risk scores for the sender and the at least one receiver are determined using predefined rules and the sender/receiver risk profiles. The risk scores identify a use level of sensitive information in the document. A determination is made by the leakage prevention system, based at least on the risk scores, whether to block a transfer of the document or to allow a transfer of the document. The document is transferred or blocked based on the determination.

### TECHNICAL FIELD

The present disclosure applies to preventing data leakage.

### BACKGROUND

In today's digital age, it is increasingly important to protect sensitive information from being leaked or accessed by unauthorized parties. One way to prevent data leakage is to implement access controls that restrict access to sensitive information based on a user's identity and permissions. However, this approach does not take into account context in which the sensitive information is being used. Failure to account for the context can lead to data leakage if the sensitive information is used in an improper context.

For example, a user with proper access permissions may be allowed to access sensitive information for a legitimate business purpose, but the user may also accidentally or intentionally leak the sensitive information if it is used in an improper context. This can occur, for example, in a personal email or social media post.

### SUMMARY

The present disclosure describes techniques that can be used for preventing data leakage by taking into account the context in which sensitive information is being used. In some implementations, a computer-implemented method includes the following. A document is analyzed by a leakage prevention system for sensitive information, where the document is sent by a sender to at least one receiver of the document. At least one context in which sensitive information is used in the document is determined by the leakage prevention system based on analyzing the document. A sender risk profile of the sender and receiver risk profiles of the at least one receiver are determined by the leakage prevention system based on the at least one context, the sender, and the at least one receiver. Risk scores for the sender and the at least one receiver are determined by the leakage prevention system using predefined rules, the sender risk profile, and the receiver risk profiles, where the risk scores identify a use level of sensitive information in the document. A determination is made by the leakage prevention system, based at least on the risk scores for the sender and the at least one receiver, whether to block a transfer of the document or to allow a transfer of the document. In response to determining that the transfer of the document is allowed, the document is transferred. In response to determining that the transfer of the document is to be blocked, the transfer of the document is blocked.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques of the present disclosure can solve the technical problem of preventing the risk of sensitive information being leaked or accessed by unauthorized parties, e.g., by automatically parsing information associated with the document. This can include subject lines and document contents, e.g., including email bodies and attached documents. Traditional access control-based approaches to data security typically do not take into account the context in which sensitive information is being used. This type of oversight can lead to data leakage if, for example, the sensitive information is used in an improper context. Other examples include data that is not identified properly and data that has been included by mistake. The techniques of the present disclosure can prevent the inadvertent leakage of sensitive data, e.g., by warning a sender of a document that includes sensitive information (and providing a confirmation option before actually sending the document). In some implementations, a system for preventing data leakage can use natural language processing and risk profiles. This can provide several advantages over traditional access control-based approaches, such as in the following three ways. First, by analyzing a context in which sensitive information is being used, and by analyzing risk profiles of a sender and a receiver, the system can prevent data leakage that may occur due to accidental or intentional misuse of the sensitive information. Second, the system can be customized to fit the specific needs and requirements of an organization by defining rules that are based on the type of sensitive information, including the intended use of the sensitive information and the specific context in which the sensitive information is being used. Third, the system can be implemented in various forms, making it easily deployable and adaptable to different types of organizations (and in other types of communications other than email).

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow chart depicting example steps of a workflow for preventing data leakage, according to some implementations of the present disclosure.

FIG. 2 is a graph depicting a distribution of risk scores based on different risk profiles, according to some implementations of the present disclosure.

FIG. 3 is a flowchart of an example of a method for determining whether a document being sent should be blocked for containing sensitive information, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for preventing data leakage by taking into account the context in which sensitive information is being used. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail, as such details are within the skill of one of ordinary skill in the art. The present disclosure is not intended to be limited to the described or illustrated implementations, but to be accorded the widest scope consistent with the described principles and features.

The techniques of the present disclosure relate to data security, and more particularly, to a system for preventing data leakage. Data leakage can be defined, for example, as an unauthorized transmission (e.g., by email) of data from within an organization to an external destination or recipient. The data can be sensitive, classified, or proprietary, for example. The techniques use natural language processing and risk profiles, in real-time, in order to identify possible data leakage, and then stop data leakage from occurring.

Some implementations for solving the technical problem of data leakage include analyzing a context in which sensitive information is being used within a document, and to determine the appropriate use of the sensitive information based on predefined rules. Natural language processing (NLP) techniques can include entity recognition, sentiment analysis, and topic modeling, among others. Predefined rules can be defined and can be used based on the type of sensitive information, the intended use of the sensitive information, and the specific context in which the sensitive information is being used. Algorithms that are implemented for processing the predefined rules can use a classical approach to NLP, where the document is tokenized and then lemmatized. Lemmatization looks beyond word reduction and considers a language's full vocabulary to apply a morphological analysis to words, aiming to remove inflectional endings only and to return the base or dictionary form of a word, which is known as the lemm. Stemming can also be used, where stemming is the process of producing morphological variants of a root/base word. Using this approach, the algorithm can determine sensitive information present in the document to be shared outside the company. Then, based on the rules of access and the recipients list, the document sending will be allowed or denied from leaving the company.

By analyzing the context in which sensitive information is being used and by enforcing predefined rules, systems and methods can prevent data leakage that may occur due to accidental or intentional misuse of the sensitive information. The systems and methods can also be customized to fit the specific needs and requirements of an organization, e.g., by defining organization unique rules based on the type of sensitive information, the intended use of the sensitive information, and the specific context in which the sensitive information is being used.

The systems and methods (or a system) for preventing data leakage can use at least NLP and risk profiles, including a number of components that work together to analyze documents for sensitive information. In this way, the systems and methods can prevent the improper use of the sensitive information, e.g., through email, social network posts, or other types of communications.

In some implementations, the techniques can begin by analyzing a document for sensitive information using NLP techniques, such as entity recognition, sentiment analysis, and topic modeling. The techniques can then determine the context in which the sensitive information is used within the document, as previously described.

The techniques can include the use of a risk assessment module. In an example of risk analysis, the sender and the receiver of the document can be analyzed, from which risk scores can be assigned based on the known risky and non-risky sender and receiver profiles. The risk scores can be used to adjust the sensitivity of the NLP analysis and the predefined rules, to determine the appropriateness of the use of the sensitive information. For example, the NLP analysis may indicate that the document is a highly-sensitive document, but analyzing profiles of the sender and the receiver(s) may indicate that this type of document has been sent in the past without incident, or that the transfer of the document (or of this type) is a normal event.

In some implementations, if the use of the sensitive information is determined to be improper based on the NLP analysis and the predefined rules, then the system can take preventative measures to block or restrict access to the sensitive information. These preventative measures can include, for example, blocking access to the document, sending an alert to the sender or a security administrator (e.g., “sensitive information is about to be sent”), or taking other appropriate action as defined by the predefined rules.

In some implementations, a computer-implemented system used to provide the techniques of the present disclosure can include the following. A natural language processing (NLP) module can be configured to analyze a document for sensitive information and to determine the context in which the sensitive information is used within the document. The NLP module can include functionality for entity recognition, sentiment analysis, and topic modeling algorithms. A risk assessment module can be configured to analyze the sender and receiver of the document, and to assign risk scores based on known risky and non-risky sender and receiver profiles. Some third-party vendors can base risk on a known history of cyber-incidents (e.g., sharing passwords, malware infection, and phishing emails) that have been tracked internally. Vendor responses and recovery rates can also be factored in to determine their cyber resilience. A set of predefined rules can be used for determining the propriety of the use of the sensitive information based on the context in which the sensitive information is used and the risk scores of the sender and receiver. A prevention module can be configured to take preventative measures to block or restrict access to the sensitive information, if the use of the sensitive information is determined to be improper based on the NLP analysis, the risk scores, and the predefined rules. The prevention module can be used to block access to the document, including to optionally send an alert (e.g., by email, text, or other communication) to the sender or a security administrator, or take other appropriate action as defined by the predefined rules. If the use of the sensitive information is determined to be improper (e.g., by parsing an email message being drafted and/or attachments), then preventative measures can be taken using features of the prevention module to block or restrict access to the sensitive information.

In some implementations, a user interface can be provided for displaying alerts and other information related to the prevention of data leakage. Such user interfaces can be presented, for example, to security administrators or managers. Information provided in the interfaces can include sender/receiver information, document information, and the reasons why the documents were blocked or restricted.

In some implementations, a workflow for preventing data leakage can use various combinations of the following steps. A document is analyzed for sensitive information using the NLP module. The context in which the sensitive information is used within the document is determined using the NLP module. The sender and receiver of the document are analyzed using the risk assessment module. Risk scores are assigned, e.g., by the risk assessment module, to both the sender and the receiver based on known risky and non-risky sender and receiver profiles. The sensitivity of the NLP analysis and the predefined rules can be adjusted (e.g., over time) based on the risk scores of the sender and receiver (e.g., that may change over time). The propriety of the use of the sensitive information can be determined based on the NLP analysis, the risk scores, and the predefined rules.

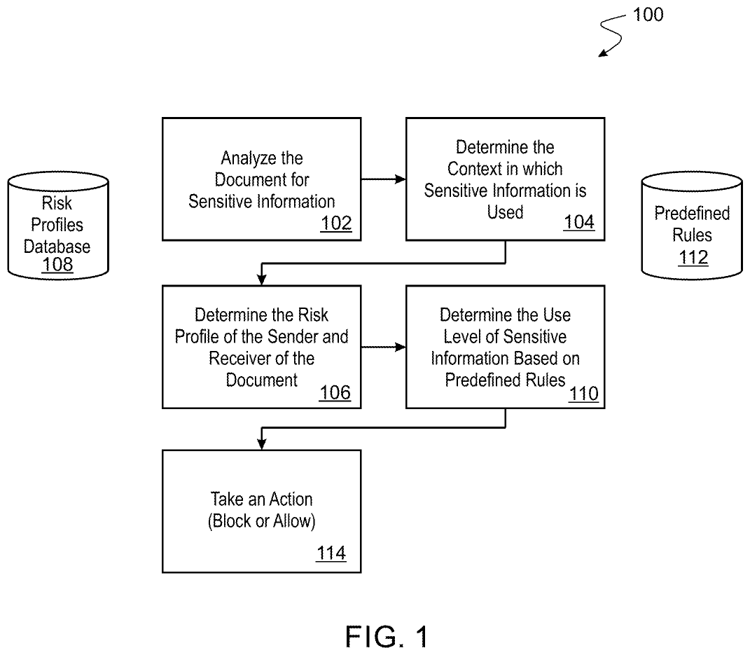

FIG. 1 is a flow chart depicting example steps of a workflow 100 for preventing data leakage, according to some implementations of the present disclosure. The workflow 100 can be used, for example, by a company or organization to prevent an undesirable spread of sensitive information, which can be inside and/or outside the company or organization.

At 102, a document (e.g., an email message or a social network post) is analyzed for sensitive information. Other documents can be used in, for example, external file transfer services or uploading to cloud-based services.

At 104, a context in which sensitive information is used is determined. Example contexts include, for example, “Sender A is a Supervisor sending a Meeting Schedule to Subordinates” and “Sender B is a Warehouse Worker sending a Part List to unknown recipients in Country C.” In an example of determining context, a part list included in the email can be examined, as well as any unknown recipients' domain addresses, to determine the risk of sending the information.

At 106, the risk profile of the sender and are receiver of the document are determined, e.g., accessed from a risk profiles database 108. Risk profiles of senders and receivers can be determined, for example, by aggregating data from different sources to determine each sender or receiver risk profile. The different sources can function as multiple parameters, e.g., including cyber incidents, phishing failures, and the number of data/documents sent out. The multiple parameters can be improved over time as new information is known about the senders/receivers or as risk models based on the parameters are developed and improved. Access to information in the risk profiles database 108 can be based, for example, of an identifier of a sender. The identifier can be, for example, an email address of the sender, a social network ID (e.g., a username) of the sender, a phone number of the sender, or some other user ID.

At 110, a use level of sensitive information is determined, e.g., based on predefined rules 112. The predefined rules can include, for example, keywords or phrases that are correlated to sensitive information. The keywords or phrases can include, for example, a name of a company or employer, a name of a project, a name of a product or service, a name of a person, an oil field location, financial records, human resources (HR) data, and employee personal information, to name a few examples.

At 114, an action is taken to either block or allow the transmission of the document, such as an email or a social network post. As an example, the transmission can alternatively be delayed or rerouted, or some other action can be performed. In some implementations, the information can be blocked or routed to a software tool/utility used by managers to review outbound documents (e.g., ANTILEAKS or some other internal/external solution). Blocking the transmission of an email can include preventing the email from being sent or blocking the actual delivery of the email (such as, if the email is not actually delivered but rather is stored in a repository of clocked emails). Blocking the transmission can occur on any Internet traffic that is routed through a company's firewalls.

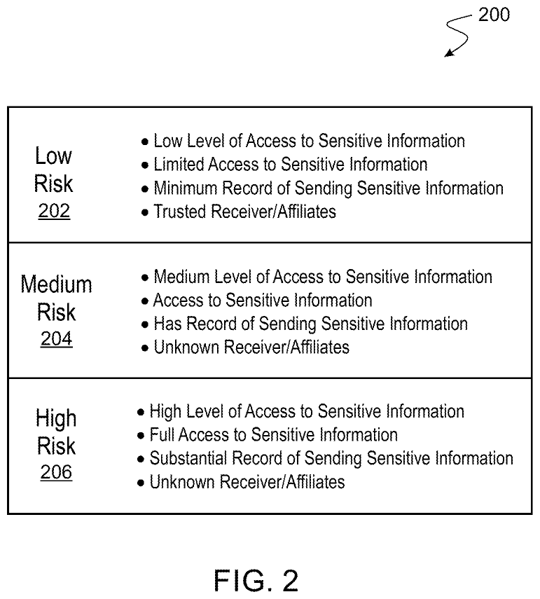

FIG. 2 is a graph 200 depicting a distribution of risk scores based on different risk profiles, according to some implementations of the present disclosure. In this example, the graph 200 shows risk scores comprising low-risk scores 202, medium-risk scores 204, and high-risk scores 206. In some implementations, instead of risk scores that are categorized as low, medium, and high, risk scores can be expressed as numeric values. In some implementations, risk scores below a predetermined level can result in a document being sent without a concern for data leakage, e.g., if the sender and recipient each have low risk scores. If one or more of the sender and receiver have a risk score in a predetermined range of medium risk, for example, a warning or other type of notification can be sent to one or more of the sender and/or recipient, e.g., indicating that potentially sensitive information has been (or may be) sent. In another example, if one or more of the sender and receiver have a risk score in a predetermined range of high risk (e.g., exceeding a high risk score threshold), then a warning or other type of notification can be sent to one or more of the sender and/or recipient, e.g., indicating that sensitive information has been sent, or the document can be prevented from being sent in the first place.

Low risk scores 202 can be assigned, for example, to senders who have a low level of access to sensitive information, limited access to sensitive information (e.g., have no access to sensitive, proprietary, or classified information), a minimum record (e.g., historically or recently) of sending sensitive information, or are known to have trusted receivers/affiliates (e.g., are known to be accepted in sending certain information to certain receivers/affiliates. Medium risk scores 204 can be assigned, for example, senders having a medium level of access to sensitive information (e.g., access to medium levels of sensitive, proprietary, or classified information), have a record of sending sensitive information, or have unknown (e.g., un-vetted) receiver/affiliates. High risk scores 206 can be assigned, for example, to senders who have a high level of access to sensitive information (e.g., a top secret/special clearance). Other high risk scores can be assigned to users with full access to sensitive, proprietary or classified information, users with a substantial record of sending sensitive information (e.g., in the past), and unknown receiver/affiliates (e.g., email addresses that are not known to be trusted recipients of information).

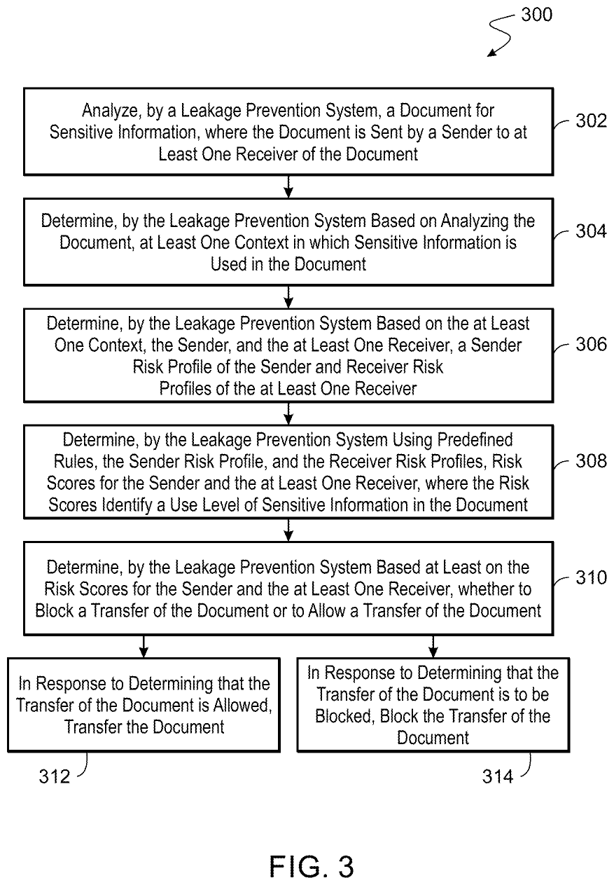

FIG. 3 is a flowchart of an example of a method 300 for determining whether a document being sent should be blocked for containing sensitive information, according to some implementations of the present disclosure. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, a document is analyzed by a leakage prevention system for sensitive information, where the document is sent by a sender to at least one receiver of the document. The document can be an email message or a social network post, for example. In some implementations, analyzing the document for sensitive information can include using natural language processing (NLP) on the contents of the document to determine if the document contains sensitive information.

In some implementations, a document can refer to an email with one or more documents attached. The described technique can be used to analyze all associated documents (that is, the email and attached documents). In the case of Hypertext Markup Language (HTML) or other document referencing links, the described technique can be used to access and analyze referenced documents.

When the document is a social network, the post is being generated by the sender to be posted on a social network. In this case, the at least one receiver of the document includes the audience of the sender, which may be the sender's social network friends. In another example, the audience can be the entire social network, such as if the settings for social network posts are set to Public. From 302, method 300 proceeds to 304.

At 304, at least one context in which sensitive information is used in the document is determined by the leakage prevention system based on analyzing the document. For example, the context that is determined can be along the lines of “Sender A is a Supervisor sending a Meeting Schedule to Subordinates” (e.g., as a context that may ultimately be determined to be low risk). In another example, the context that is determined can be along the lines of “Sender B is a Warehouse Worker sending a Part List to unknown recipients in Country C” (e.g., as a context that may ultimately be determined to be high risk). From 304, method 300 proceeds to 306.

At 306, a sender risk profile of the sender and receiver risk profiles of the at least one receiver are determined by the leakage prevention system based on the at least one context, the sender, and the at least one receiver. As an example, profiles of the sender and receiver(s) can be accessed directly from the risk profiles database 108. In another example, profiles of the sender and receiver(s) can be generated in real-time based on information accessed from the risk profiles database 108. The receiver profile(s) that are determined can be identified, for example, by an email recipients list (e.g., a combination of To, CC, and BCC lists) or by the user names of the audience of an intended social network post. From 306, method 300 proceeds to 308.

At 308, risk scores for the sender and the at least one receiver are determined by the leakage prevention system using predefined rules, the sender risk profile, and the receiver risk profiles, where the risk scores identify a use level of sensitive information in the document. The risk scores can include a low risk score, a medium risk score, and a high risk score. The risk scores can be determined from risky and non-risky profiles of both the sender and the at least one receiver. From 308, method 300 proceeds to 310.

At 310, a determination is made by the leakage prevention system, based at least on the risk scores for the sender and the at least one receiver, whether to block a transfer of the document or to allow a transfer of the document. The determination can be based, for example, on whether one or more risk scores exceeds a threshold. In some implementations, the determination can be made based on a mathematical function of the risk scores. The function can be, for example, a sum or a weighted sum, and can factor in the number of recipients. A number of recipients can be represented by a high number, for example, if an email is directed to a large distribution list or an entire company, or in the case of a social network post, an audience of many friends or an audience of the public. From 310, method 300 proceeds to either 312 or 314.

At 312, in response to determining that the transfer of the document is allowed, the document is transferred. For example, the email message can be allowed to be sent, or the social network post can be allowed to be posted.

At 314, in response to determining that the transfer of the document is to be blocked, the transfer of the document is blocked. For example, the email message can be blocked, or the social network post can be blocked. After 312 or 314, method 300 can stop.

In some implementations, method 300 can further include: determining that one or more of the sender and at least one receiver have a risk score exceeding a high risk score threshold; and sending a notification to one or more of the at least one receiver indicating that sensitive information has been sent (or in some cases, blocked). Thresholds can be a numeric risk score threshold or can be set to include High (or Medium and High) risk scores.

In some implementations, configurations of the present disclosure can be embedded in one or more data files (e.g., flat file, text file, binary file, JAVASCRIPT Object Notation (JSON), extensible Markup Language (XML), spreadsheet, or database table). In some implementations, a graphical user interface (not illustrated) can be used that allows users to display information, input values to be stored for usage (for example, in the previously mentioned data files), and to interact with the system.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

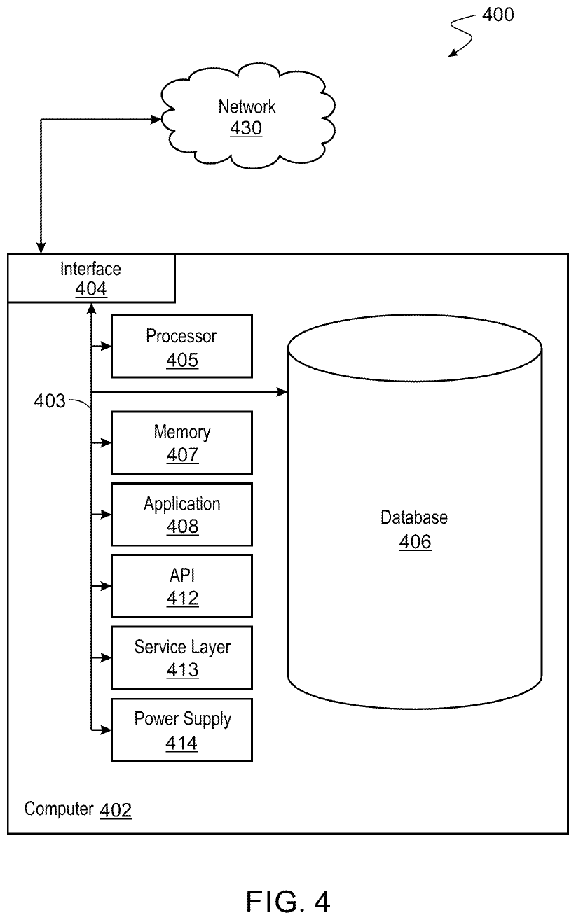

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method includes the following. A document is analyzed by a leakage prevention system for sensitive information, where the document is sent by a sender to at least one receiver of the document. At least one context in which sensitive information is used in the document is determined by the leakage prevention system based on analyzing the document. A sender risk profile of the sender and receiver risk profiles of the at least one receiver are determined by the leakage prevention system based on the at least one context, the sender, and the at least one receiver. Risk scores for the sender and the at least one receiver are determined by the leakage prevention system using predefined rules, the sender risk profile, and the receiver risk profiles, where the risk scores identify a use level of sensitive information in the document. A determination is made by the leakage prevention system, based at least on the risk scores for the sender and the at least one receiver, whether to block a transfer of the document or to allow a transfer of the document. In response to determining that the transfer of the document is allowed, the document is transferred. In response to determining that the transfer of the document is to be blocked, the transfer of the document is blocked.

The foregoing and other described implementations can each, optionally, include one or more of the following features:

A first feature, combinable with any of the following features, where the document is an email message.

A second feature, combinable with any of the previous or following features, where the document is a social network post being generated by the sender to be posted on a social network by the sender.

A third feature, combinable with any of the previous or following features, where the at least one receiver of the document includes a social network audience of the social network post.

A fourth feature, combinable with any of the previous or following features, where the risk scores include a low-risk score, a medium-risk score, and a high-risk score, and where the risk scores are determined from risky and non-risky profiles.

A fifth feature, combinable with any of the previous or following features, the method further including: determining that one or more of the sender and at least one receiver have a risk score exceeding a high-risk score threshold; and sending a notification to one or more of the at least one receiver indicating that sensitive information has been sent.

A sixth feature, combinable with any of the previous or following features, where analyzing the document for sensitive information includes using natural language processing (NLP) on contents of the document to determine if the document contains sensitive information.

In a second implementation, a non-transitory, computer-readable medium stores one or more instructions executable by a computer system to perform operations including the following. A document is analyzed by a leakage prevention system for sensitive information, where the document is sent by a sender to at least one receiver of the document. At least one context in which sensitive information is used in the document is determined by the leakage prevention system based on analyzing the document. A sender risk profile of the sender and receiver risk profiles of the at least one receiver are determined by the leakage prevention system based on the at least one context, the sender, and the at least one receiver. Risk scores for the sender and the at least one receiver are determined by the leakage prevention system using predefined rules, the sender risk profile, and the receiver risk profiles, where the risk scores identify a use level of sensitive information in the document. A determination is made by the leakage prevention system, based at least on the risk scores for the sender and the at least one receiver, whether to block a transfer of the document or to allow a transfer of the document. In response to determining that the transfer of the document is allowed, the document is transferred. In response to determining that the transfer of the document is to be blocked, the transfer of the document is blocked.

The foregoing and other described implementations can each, optionally, include one or more of the following features:

A first feature, combinable with any of the following features, where the document is an email message.

A second feature, combinable with any of the previous or following features, where the document is a social network post being generated by the sender to be posted on a social network by the sender.

A third feature, combinable with any of the previous or following features, where the at least one receiver of the document includes a social network audience of the social network post.

A fourth feature, combinable with any of the previous or following features, where the risk scores include a low-risk score, a medium-risk score, and a high-risk score, and where the risk scores are determined from risky and non-risky profiles.

A fifth feature, combinable with any of the previous or following features, the operations further including: determining that one or more of the sender and at least one receiver have a risk score exceeding a high-risk score threshold; and sending a notification to one or more of the at least one receiver indicating that sensitive information has been sent.

A sixth feature, combinable with any of the previous or following features, where analyzing the document for sensitive information includes using natural language processing (NLP) on contents of the document to determine if the document contains sensitive information.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A document is analyzed by a leakage prevention system for sensitive information, where the document is sent by a sender to at least one receiver of the document. At least one context in which sensitive information is used in the document is determined by the leakage prevention system based on analyzing the document. A sender risk profile of the sender and receiver risk profiles of the at least one receiver are determined by the leakage prevention system based on the at least one context, the sender, and the at least one receiver. Risk scores for the sender and the at least one receiver are determined by the leakage prevention system using predefined rules, the sender risk profile, and the receiver risk profiles, where the risk scores identify a use level of sensitive information in the document. A determination is made by the leakage prevention system, based at least on the risk scores for the sender and the at least one receiver, whether to block a transfer of the document or to allow a transfer of the document. In response to determining that the transfer of the document is allowed, the document is transferred. In response to determining that the transfer of the document is to be blocked, the transfer of the document is blocked.

The foregoing and other described implementations can each, optionally, include one or more of the following features:

A first feature, combinable with any of the following features, where the document is an email message.

A second feature, combinable with any of the previous or following features, where the document is a social network post being generated by the sender to be posted on a social network by the sender.

A third feature, combinable with any of the previous or following features, where the at least one receiver of the document includes a social network audience of the social network post.

A fourth feature, combinable with any of the previous or following features, where the risk scores include a low-risk score, a medium-risk score, and a high-risk score, and where the risk scores are determined from risky and non-risky profiles.

A fifth feature, combinable with any of the previous or following features, the operations further including: determining that one or more of the sender and at least one receiver have a risk score exceeding a high-risk score threshold; and sending a notification to one or more of the at least one receiver indicating that sensitive information has been sent.

A sixth feature, combinable with any of the previous or following features, where analyzing the document for sensitive information includes using natural language processing (NLP) on contents of the document to determine if the document contains sensitive information.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for reading and updating. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together into a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
analyzing, by a leakage prevention system, a document for sensitive information, wherein the document is sent by a sender to at least one receiver of the document;
determining, by the leakage prevention system based on analyzing the document, at least one context in which sensitive information is used in the document;
determining, by the leakage prevention system based on the at least one context, the sender, and the at least one receiver, a sender risk profile of the sender and receiver risk profiles of the at least one receiver;
determining, by the leakage prevention system using predefined rules, the sender risk profile, and the receiver risk profiles, risk scores for the sender and the at least one receiver, wherein the risk scores identify a use level of sensitive information in the document; and
determining, by the leakage prevention system based at least on the risk scores for the sender and the at least one receiver, whether to block a transfer of the document or to allow a transfer of the document.

2. The computer-implemented method of claim 1, wherein the document is an email message.

3. The computer-implemented method of claim 1, wherein the document is a social network post being generated by the sender to be posted on a social network by the sender.

4. The computer-implemented method of claim 3, wherein the at least one receiver of the document includes a social network audience of the social network post.

5. The computer-implemented method of claim 1, wherein the risk scores include a low-risk score, a medium-risk score, and a high-risk score, and wherein the risk scores are determined from risky and non-risky profiles.

6. The computer-implemented method of claim 1, further comprising:
determining that one or more of the sender and at least one receiver have a risk score exceeding a high-risk score threshold; and
sending a notification to one or more of the at least one receiver indicating that sensitive information has been sent.

7. The computer-implemented method of claim 1, wherein analyzing the document for sensitive information includes using natural language processing (NLP) on contents of the document to determine if the document contains sensitive information.

8. A non-transitory, computer-readable medium storing one or more instructions executable by a computer system to perform operations comprising:
analyzing, by a leakage prevention system, a document for sensitive information, wherein the document is sent by a sender to at least one receiver of the document;
determining, by the leakage prevention system based on analyzing the document, at least one context in which sensitive information is used in the document;
determining, by the leakage prevention system based on the at least one context, the sender, and the at least one receiver, a sender risk profile of the sender and receiver risk profiles of the at least one receiver;
determining, by the leakage prevention system using predefined rules, the sender risk profile, and the receiver risk profiles, risk scores for the sender and the at least one receiver, wherein the risk scores identify a use level of sensitive information in the document; and
determining, by the leakage prevention system based at least on the risk scores for the sender and the at least one receiver, whether to block a transfer of the document or to allow a transfer of the document.

9. The non-transitory, computer-readable medium of claim 8, wherein the document is an email message.

10. The non-transitory, computer-readable medium of claim 8, wherein the document is a social network post being generated by the sender to be posted on a social network by the sender.

11. The non-transitory, computer-readable medium of claim 10, wherein the at least one receiver of the document includes a social network audience of the social network post.

12. The non-transitory, computer-readable medium of claim 8, wherein the risk scores include a low-risk score, a medium-risk score, and a high-risk score, and wherein the risk scores are determined from risky and non-risky profiles.

13. The non-transitory, computer-readable medium of claim 8, the operations further comprising:
determining that one or more of the sender and at least one receiver have a risk score exceeding a high-risk score threshold; and
sending a notification to one or more of the at least one receiver indicating that sensitive information has been sent.

14. The non-transitory, computer-readable medium of claim 8, wherein analyzing the document for sensitive information includes using natural language processing (NLP) on contents of the document to determine if the document contains sensitive information.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
analyzing, by a leakage prevention system, a document for sensitive information, wherein the document is sent by a sender to at least one receiver of the document;
determining, by the leakage prevention system based on analyzing the document, at least one context in which sensitive information is used in the document;
determining, by the leakage prevention system based on the at least one context, the sender, and the at least one receiver, a sender risk profile of the sender and receiver risk profiles of the at least one receiver;
determining, by the leakage prevention system using predefined rules, the sender risk profile, and the receiver risk profiles, risk scores for the sender and the at least one receiver, wherein the risk scores identify a use level of sensitive information in the document; and
determining, by the leakage prevention system based at least on the risk scores for the sender and the at least one receiver, whether to block a transfer of the document or to allow a transfer of the document.

16. The computer-implemented system of claim 15, wherein the document is an email message.

17. The computer-implemented system of claim 15, wherein the document is a social network post being generated by the sender to be posted on a social network by the sender.

18. The computer-implemented system of claim 17, wherein the at least one receiver of the document includes a social network audience of the social network post.

19. The computer-implemented system of claim 15, wherein the risk scores include a low-risk score, a medium-risk score, and a high-risk score, and wherein the risk scores are determined from risky and non-risky profiles.

20. The computer-implemented system of claim 15, the operations further comprising:
determining that one or more of the sender and at least one receiver have a risk score exceeding a high-risk score threshold; and
sending a notification to one or more of the at least one receiver indicating that sensitive information has been sent.
